(19) United States
(12) Patent Application Publication
(10) Pub. No.: US 2020/0028424 A1
(43) Pub. Date: Jan. 23, 2020

(54) PERMANENT MAGNET THREE PHASE MACHINE FOR HIGH SPEED APPLICATIONS HAVING LOW VIBRATION AND LOW RESISTIVE LOSSES

(71) Applicant: KONINKLIJKE PHILIPS N.V., Eindhoven (NL)

(72) Inventor: RUSSELL HUGHES NORRIS, MURRYSVILLE, PA (US)

(21) Appl. No.: 16/497,544

(22) PCT Filed: Mar. 29, 2018
(86) PCT No.: PCT/EP2018/058074

§ 371 Date: Sep. 25, 2019

Related U.S. Application Data
(60) Provisional application No. 62/479,713, filed on Mar. 31, 2017.

(51) Int. Cl. H02K 29/03; H02K 21/22; H02K 3/28

(52) U.S. Cl. CPC H02K 29/03; H02K 3/28; H02K 21/22

(57) ABSTRACT

A compact three-phase permanent magnet rotary machine having minimal reluctance torque and electromagnetic torque ripple, and maximum energy efficiency and starting torque per unit volume of winding, comprises an armature having 3(2n+1) ferromagnetic poles and slots, where n is an integer of 1 or more, and a permanent magnet assembly having either 2, 4 or 6 permanent magnet poles. Each of the three phases of the winding comprises multiple coils, each wound about a respective ferromagnetic pole and occupying a pair of slots located immediately on each side of a respective pole. The coils of a particular phase are located within a sector of the circular array of ferromagnetic poles encompassing 2n+1 poles.

### BACKGROUND OF THE INVENTION

### 1. Field of the Invention

The present invention relates to improvements in three-phase permanent magnet rotary electrical machines such as motors and generators. More particularly, the invention relates to such improvements which minimize reluctance torque and electromagnetic torque ripple while maximizing compactness, energy efficiency, motor starting torque per unit volume of winding, and operating speed. The invention also relates to such improvements which move the 1^{st} and subsequent harmonics of reluctance torque and electromagnetic ripple from a lower frequency range to a higher frequency range which may be less likely heard and felt by a human.

### 2. Description of the Related Art

Permanent magnet motors having slotted armatures and multi-coil phases have been produced in the past utilizing an odd number of slots and armature poles and an even number of permanent magnet poles to reduce reluctance torque and thus vibration, as exemplified by the motors shown in U.S. Pat. Nos. 4,437,029 and 4,532,449. However, the coils of the windings for such motors are either superimposed upon each other or, if not superimposed, require the use of more than three phases. In the former case, the superimposed coils tend to maximize the amount of wire in the winding, thereby maximizing both its volume and impedance and minimizing its efficiency and torque (or emf) per turn. In the latter case, the large number of phases is undesirable due to the need for a correspondingly high number of phase-switching circuits which add complexity and expense.

Three-phase permanent magnet motors, having multi-coil phases wherein the individual coils are not superimposed upon each other, have been designed. However, even though the coils do not overlap, the phases may overlap since the coils of one phase can be interstitially inserted between the coils of another phase. Such winding configuration, although minimizing self-inductance which is beneficial in high-speed applications, produces electromagnetic torque ripple and reduced starting torque per unit volume of wire, both of which are disadvantageous in many applications.

Conversely, motors having equal numbers of armature slots and permanent magnet poles, as exemplified by U.S. Pat. No. 4,188,556, are characterized by considerable reluctance, or “cogging”, torque which produces harmful vibration in many applications.

A design which attempted to address such deficiencies in the art is described in U.S. Pat. No. 4,774,428. Such design is generally effective but only at lower speeds (e.g., 6 krpm to 15 krpm). At higher speeds, the relatively high pole count of such design requires very high pulse width modulation (PWM) switching leading to higher controller field-effect transistor (FET) and core losses.

Accordingly, a need exists for a three-phase, permanent magnet rotary electrical machine which compatibly satisfies all of the objectives of compactness, minimal reluctance torque and electromagnetic torque ripple, maximum energy efficiency and starting torque per unit volume of wire, which is suitable for high speed (e.g., above 15 krpm) operation.

### SUMMARY OF THE INVENTION

The present invention provides a unique combination of features which compatibly satisfies all of the foregoing competing objectives in a three-phase permanent magnet rotary machine such as a motor or generator. The machine may have an armature which is either internal or external relative to the permanent magnet assembly, and may have either a radial or an axial gap. Pursuant to the principles of the invention, an armature, having a ferromagnetic core with 3(2n+1) protruding ferromagnetic poles (n being an integer of one or more) arranged in a circular array separated from each other by a like number of slots, and a permanent magnet assembly having a circular array of two, four, or six magnetic poles, are mounted for relative rotation with respect to each other. This structure enables the utilization of three phases, each having multiple coils, in combination with permanent magnet poles of a different number than the ferromagnetic poles of the armature, so that the magnitude of the reluctance torque is minimized while its frequency per revolution is maximized. Compactness and high energy efficiency of the three-phase winding is achieved by winding each coil of each phase about a respective ferromagnetic armature pole so that each coil occupies a pair of slots located immediately on each side of the respective armature pole. This structure avoids any overlapping of the respective coils, thereby minimizing the volume of coil wire and thereby also minimizing the impedance of the winding while maximizing its efficiency and torque (or emf) per turn.

The minimizing of electromagnetic torque ripple and the maximizing of starting torque per unit volume of wire are achieved by concentrating the coils of each phase into a limited sector of the armature so that the phases, as well as their individual coils, do not overlap each other. This is achieved by making the coils of each phase occupy 2n+2 armature slots located within a sector of the armature poles which encompasses only 2n+1 armature poles, and winding the coils with or without alternating polarities. Although close placement of coils of alternating polarity increases the self-inductance of each phase, the resultant increase in impedance is insignificant except at unusually high motor speeds.

In an embodiment, a three-phase permanent magnet rotary electrical machine is provided. The machine comprises: an armature having a ferromagnetic core with 3(2n+1) protruding ferromagnetic poles arranged in a circular array separated from each other by the same number of slots located interstitially between said ferromagnetic poles, where n is an integer of 1 or more; a permanent magnet assembly having a circular array of either two, four or six magnetic poles; a means for mounting said armature and said permanent magnet assembly for relative rotation with respect to each other; and a three-phase coil means mounted on said armature within said slots, each of the three phases of said coil means comprising multiple coils, each coil being wound about a respective ferromagnetic pole and each said pole being wound with a coil of a single phase.

Each coil may occupy a pair of slots located immediately on each side of the ferromagnetic pole.

The coils within a phase may be interstitially separated from one another by other phases.

All of the coils of each phase may be located within a predetermined sector of the circular array of ferromagnetic poles, the coils of each phase of said coil means being wound with the same or alternating polarities, and occupying 2n+2 slots and being located within a sector of said circular array of ferromagnetic poles encompassing 2n+1 ferromagnetic poles.

The permanent magnet assembly may include only two magnetic poles. The permanent magnet assembly may include only four magnetic poles. The permanent magnet assembly may include six magnetic poles.

The armature may be disposed interior to the permanent magnet assembly.

The armature may be disposed exterior to the permanent magnet assembly.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1 is a schematic drawing of an exemplary radial-gap embodiment of the invention;

FIG. 1A is a schematic diagram of one embodiment of a winding suitable for the device of FIG. 1;

FIG. 1B is a schematic diagram of an alternative winding embodiment suitable for the device of FIG. 1;

FIG. 2 is a schematic drawing of another exemplary radial-gap embodiment of the invention;

FIG. 3 is a schematic diagram of yet another exemplary radial gap embodiment of the invention; and

FIG. 4 is a schematic diagram of yet a further exemplary radial gap embodiment of the invention.

### DETAILED DESCRIPTION OF EXEMPLARY EMBODIMENTS

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other. As used herein, “fixedly coupled” or “fixed” means that two components are coupled so as to move as one while maintaining a constant orientation relative to each other.

As used herein, the word “unitary” means a component is created as a single piece or unit. That is, a component that includes pieces that are created separately and then coupled together as a unit is not a “unitary” component or body. As employed herein, the statement that two or more parts or components “engage” one another shall mean that the parts exert a force against one another either directly or through one or more intermediate parts or components. As employed herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

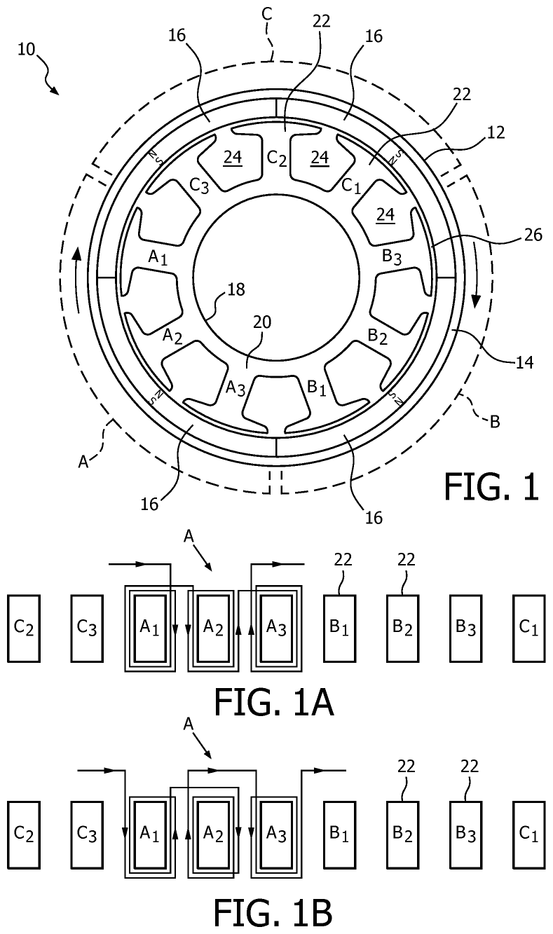

With reference to an example embodiment of the invention shown in FIG. 1, the rotary electrical machine indicated generally as 10 comprises an external permanent magnet rotor assembly 12 comprising a ferromagnetic annular core or housing 14, on the inner surface of which is mounted a circular array of radially or diametrically (parallel) magnetized permanent magnets 16 of ceramic ferrite, rare earth cobalt or other suitable type. An armature 18 serves as the stator and comprises a laminated, ferromagnetic core 20 having protruding ferromagnetic poles 22 arranged in a circular array separated from each other by slots 24 located interstitially between the poles 22, and separated from the poles of the respective permanent magnets 16 by an annular radial gap 26.

The rotor and stator may be mounted for relative rotation with respect to each other by any suitable bearing assembly, such as that shown in U.S. Pat. No. 4,540,906, the contents of which is incorporated herein by reference. Although the permanent magnet rotor assembly enables brushless commutation, the permanent magnet assembly could, alternatively, serve as the stator in cooperation with a mechanically commutated armature.

The respective locations of the three phases A, B and C of the winding for the device of FIG. 1 are indicated in FIG. 1 by the respective sets of ferromagnetic armature poles A1, A2, A3; B1, B2, B3; and C1, C2, C3. As shown in FIG. 1A, which is a schematic radial view of the respective armature poles extended into a straight line, a typical phase such as A has three coils, each wound about a respective armature pole such as A1, A2, A3 and occupying a pair of slots located immediately adjacent to each side of the respective armature pole so that none of the coils overlaps any other coil. Phases B and C, respectively, are wound on their respective poles B1, B2, B3 and C1, C2, C3 identically to phase A, although the direction of the current depends on the commutation as is well-known to those skilled in the art. FIG. 1B shows an alternative configuration for phase A, the other two phases B and C being wound identically. It is to be appreciated that other arrangements of phases A, B, and C may be employed to achieve a different performance.

In both embodiments of the winding shown in FIGS. 1A and 1B, not only are the individual coils not superimposed upon each other, but the phases likewise are not superimposed upon each other. Rather, each phase A, B, C is limited to a respective exclusive sector, as shown in dashed lines in FIG. 1, of the circular array of armature poles 22. The avoidance of overlapping coils provides maximum compactness and efficiency by minimizing the volume of wire needed, while the avoidance of overlapping phases minimizes electromagnetic torque ripple and maximizes starting torque per unit volume of wire. Thus each pole is wound with a coil of a single phase and each coil therefore occupies the pair of slots 24 located immediately on each side of the respective armature pole 22.

On the other hand, the combination of four permanent magnet poles (of the four permanent magnets 16) and nine ferromagnetic armature poles 22 minimizes the strength of the 1^{st} harmonic of the reluctance torque and electromagnetic ripple by dividing the torque among a greater number of teeth and slots. Also, the arrangement moves the 1^{st} harmonic of reluctance torque and electromagnetic ripple from a lower audible frequency range to a higher frequency range which may be less likely to be heard or felt by a human. The use of 3(2n+1) teeth or slots distributes the phase winding turns about the armature in such a way as to reduce the amount of copper and thereby reduces copper losses.

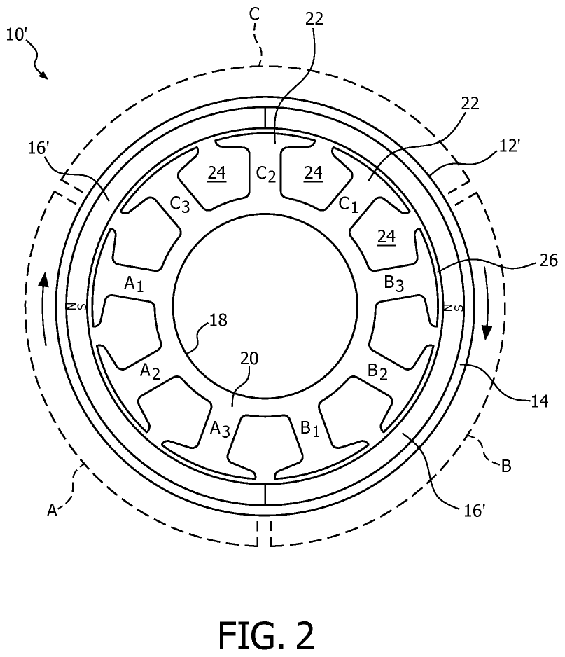

The same principles apply to other embodiments of the invention featuring different numbers of permanent magnet poles and ferromagnetic poles, as long as the number of ferromagnetic poles equals 3(2n+1), where n is an integer of 1 or more, and the number of permanent magnet poles equals either 2, 4, or 6. An example arrangement of a rotary electrical machine, indicated generally as 10′, similar to machine 10 of FIG. 1, which utilizes only two permanent magnets 16′ (and thus only two magnetic poles) in a permanent magnet rotor assembly 12′ is shown in FIG. 2.

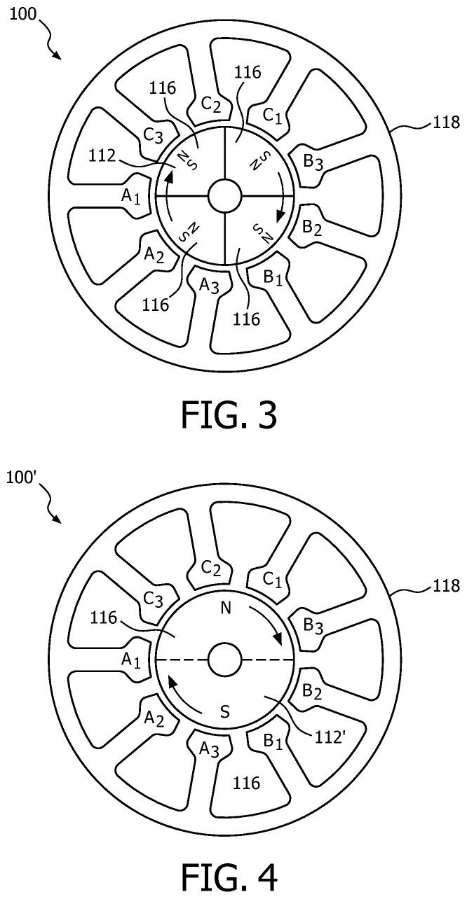

As a further alternative, the armature could be the exterior element, serving either as stator or rotor, with the permanent magnet assembly located interior thereof. FIGS. 3 and 4 show examples of rotary electrical machines 100 and 100′ in accordance with example embodiments of the invention having permanent magnet rotor assemblies 112 and 112′ which are interior to an outer armature 118. Rotor assembly 112 of FIG. 3, similar to rotor assembly 12 of FIG. 1, utilizes four permanent magnetic poles and thus includes four permanent magnets 116. Rotor assembly 112′ of FIG. 4, similar to rotor assembly 12′ of FIG. 2, utilizes two permanent magnetic poles and thus includes one permanent magnet 116 (of which both magnetic poles are utilized).

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A three-phase permanent magnet rotary electrical machine comprising:
an armature having a ferromagnetic core with 3(2n+1) protruding ferromagnetic poles arranged in a circular array separated from each other by the same number of slots located interstitially between said ferromagnetic poles, where n is an integer of 1 or more;
a permanent magnet assembly having a circular array of only either two, four or six magnetic poles;
a means for mounting said armature and said permanent magnet assembly for relative rotation with respect to each other; and
a three-phase coil means mounted on said armature within said slots, each of the three phases of said coil means comprising multiple coils, each coil being wound about a respective ferromagnetic pole and each said pole being wound with a coil of a single phase.

2. The three-phase permanent magnet rotary electrical machine of claim 1, wherein each coil occupies a pair of slots located immediately on each side of the ferromagnetic pole.

3. The three-phase permanent magnet rotary electrical machine of claim 1, wherein the coils within a phase are interstitially separated from one another by other phases.

4. The three-phase permanent magnet rotary electrical machine of claim 1, wherein all of the coils of each phase are located within a predetermined sector of the circular array of ferromagnetic poles, the coils of each phase of said coil means being wound with the same or alternating polarities, and occupying 2n+2 slots and being located within a sector of said circular array of ferromagnetic poles encompassing 2n+1 ferromagnetic poles.

5. The rotary electrical machine of claim 1, wherein the permanent magnet assembly includes only two magnetic poles.

6. The rotary electrical machine of claim 1, wherein the permanent magnet assembly includes only four magnetic poles.

7. The rotary electrical machine of claim 1, wherein the permanent magnet assembly includes six magnetic poles.

8. The rotary electrical machine of claim 1, wherein the armature is disposed interior to the permanent magnet assembly.

9. The rotary electrical machine of claim 1, wherein the armature is disposed exterior to the permanent magnet assembly.
